(19) United States
(12) Patent Application Publication
(10) Pub. No.: US 2006/0181804 A1
(43) Pub. Date: Aug. 17, 2006

(54) Tape recording and reproducing apparatus

(75) Inventor: Myoung-sub Jang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/188,713

(22) Filed: Jul. 26, 2005

(30) Foreign Application Priority Data
Jul. 26, 2004 (KR) 10-2004-0058111

(51) Int. Cl. G11B 15/00

(52) U.S. Cl. 360/90

(57) ABSTRACT

A damping member of a tape recording and/or reproducing apparatus, the apparatus having a main chassis and a capstan motor with a metallic substrate, wherein the damping member is removably provided to the main chassis to maintain a substantially constant spacing between the main chassis and the metallic substrate.

### CROSS-REFERENCE TO RELATED APPLICATIONS

This application claims the benefit of Korean Patent Application No. 2004-58111, filed on Jul. 26, 2004, in the Korean Intellectual Property Office, the disclosure of which is incorporated herein by reference.

### BACKGROUND OF THE INVENTION

1. Field of the Invention

The present invention relates to a tape recording and reproducing apparatus.

2. Description of the Related Art

In general, a tape recording and reproducing apparatus, such as a VCR and a camcorder, has a main chassis equipped with a head drum, and a supply reel and a take-up reel mounted on the main chassis to drive a tape cassette loaded in the apparatus. A capstan motor is also mounted on the main chassis to selectively drive the reels.

As shown in FIG. 1, the capstan motor 20 includes a capstan axle 21, a drive 23 to drive the capstan axle 21, and a metallic substrate 25 connected to the drive 23. The capstan motor 20 is mounted in such a manner that the capstan motor is projected above the top surface of the main chassis, and guides the running of the tape. In addition, the drive 23 and the metallic substrate 25 are located at the rear side of the main chassis to provide a driving force to the reels. The metallic substrate 25 is connected to the drive 23, whereby the metallic substrate and the drive are employed as a single unit. The metallic substrate 25 is also connected to the head drum beyond the drive 23, thereby being capable of controlling the driving of the head drum.

With the arrangement described above, because the metallic substrate 25 and the main chassis are formed from metal, sparks or electric errors may be caused when the metallic substrate 25 and the main chassis come into contact with each other. Accordingly, the metallic substrate 25 should be spaced from the main chassis in a stable fashion.

In particular, because the metallic substrate 25 takes a form of a relatively thin and broad plate shape, the metallic substrate 25 may contact the main chassis due to vibrations caused when the drive 23 is driven. Therefore, it is required that the metallic substrate 25 of the capstan motor 20 maintain a predetermined distance in relation to the main chassis in a stable posture.

### SUMMARY OF THE INVENTION

Accordingly, the present invention solves the above-mentioned and/or other problems, and an aspect of the present invention is to provide an improved magnetic recording and reproducing apparatus, wherein a capstan motor can be stably supported in relation to a main chassis.

Additional aspects and/or advantages of the invention will be set forth in part in the description which follows and, in part, will be apparent from the description, or may be learned by practice of the invention.

In order to achieve the above and/or other aspects, there is provided a tape recording and/or reproducing apparatus comprising a main chassis provided with a head drum; a capstan motor coupled to the main chassis and provided with a drive and a metallic substrate; and a damping member removably provided to the main chassis, wherein at least a part of the damping member is interposed between the metallic substrate and the main chassis.

The main chassis may be formed with a connection opening, wherein at least a portion of the damping member extends through the connection opening in response to the damping member being coupled to the main chassis.

The connection opening may be formed to expose an edge of the metallic substrate.

The drive and the metallic substrate may be provided on a bottom surface of the main chassis, and the damping member may be coupled to the connection opening from the top surface of the metallic substrate.

The damping member may comprise an axial part extending through an area not occupied by the metallic substrate in response to the damping member being inserted into the connection opening; and a damping rib extending from the axial part so that the damping rib is interposed between the bottom surface of the main chassis and the metallic substrate.

The damping member may further comprise a first clamping member formed to be substantially vertically spaced from the damping rib, wherein the first clamping member contacts the top surface of the main chassis and cooperates with the damping rib to clamp the main chassis.

The damping member may further comprise a second clamping member formed to be vertically spaced from the damping rib, wherein the second clamping member contacts the bottom surface of the main chassis and cooperates with the damping rib to clamp the metallic substrate.

The tape recording and/or reproducing apparatus may further comprise a locking part to prevent a movement of the damping member from a coupled position into which the damping member is rotated by a predetermined angle after having been inserted into the connection opening.

The locking part may comprise a locking hole formed adjacent to the connection opening; and an elastic rib, having a locking projection, formed on the damping member, wherein the locking projection is resiliently inserted into the locking hole in response to the damping member being in the coupled position.

Also, in order to achieve the above and/or other aspects, there is provided a tape recording and/or reproducing apparatus comprising a main chassis; a capstan motor, having a metallic substrate, coupled to the main chassis; and a damping member removably provided to the main chassis, herein the damping member maintains a substantially constant spacing between the main chassis and the metallic substrate.

Also, in order to achieve the above and/or other aspects, there is provided a damping member of a tape recording and/or reproducing apparatus, the apparatus having a main chassis and a capstan motor with a metallic substrate, wherein the damping member is removably provided to the main chassis to maintain a substantially constant spacing between the main chassis and the metallic substrate.

### BRIEF DESCRIPTION OF THE DRAWINGS

These and/or other aspects and advantages of the invention will be apparent and more readily appreciated from the following description of the embodiments, taken in conjunction with the accompanying drawings of which:

FIG. 1 is a perspective view illustrating a capstan motor employed in a conventional tape recording and reproducing apparatus;

FIG. 2 is a perspective view schematically illustrating a tape recording and reproducing apparatus according to an embodiment of the present invention

FIGS. 3A and 3B are perspective views illustrating a damping member employed in the tape recording and reproducing apparatus shown in FIG. 2;

FIG. 4 is a top plan view illustrating a main part of a main chassis, from which the damping member is removed, employed in the tape recording and reproducing apparatus shown in FIG. 2;

FIG. 5 is a top plan view illustrating a state in which the damping member is inserted into a connection opening of the main chassis;

FIG. 6 is a top plan view illustrating a state in which the damping member is rotated from the state shown in FIG. 5; and

FIG. 7 is a cross-sectional view taken along line I-II of FIG. 6.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The matters defined in the description, such as examples of detailed construction and/or other elements, are merely provided to assist in a comprehensive understanding of the invention. Thus, it is apparent that the present invention can be carried out without those defined matters. Also, other well-known functions or constructions may not be described in detail so as not to unnecessarily obscure the invention.

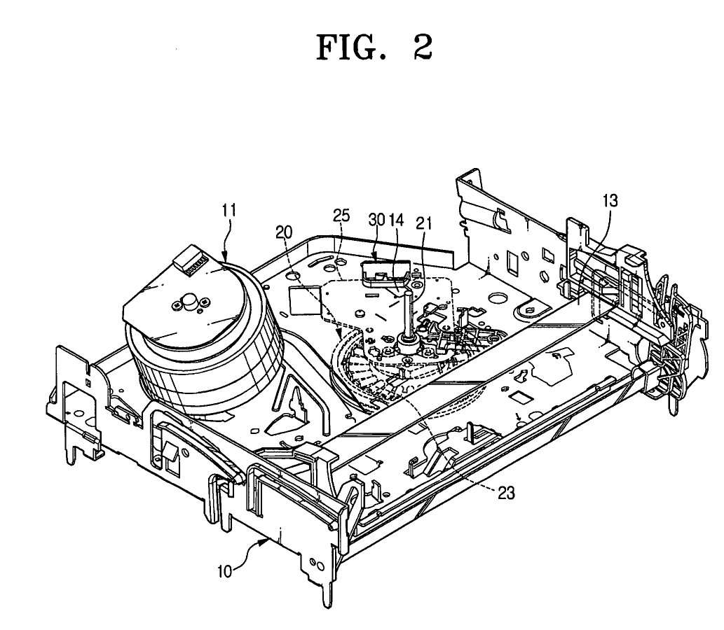

Referring to FIG. 2, the tape recording and/or reproducing apparatus according to an embodiment of the present invention includes a main chassis 10 equipped with a head drum 11 on the top surface of thereof, a capstan motor 20 mounted on the main chassis 10, and a damping member 30 removably mounted on the main chassis 10.

The head drum 11 records information onto a tape released and running from the tape cassette loaded on the main chassis 10, or reproduces information recorded on the tape. A guide member having a guide pole to guide the running of the tape is provided on the main chassis 10, and a take-up reel and a supply reel are rotatably mounted on the main chassis 10 to rotate the tape reels of the tape cassette seated on the take-up and supply reels. A loading member is also provided on the main chassis 10 to load and unload the tape cassette. Because the guide member, take-up reel, supply reel and loading member are well-known in the conventional art, they are neither shown nor described in detail. In FIG. 2, reference numeral 13 indicates a cassette holder on which the cassette tape is seated. The cassette holder 13 is slidably mounted on the main chassis 10, thereby moving the tape cassette to be seated on the main chassis 10.

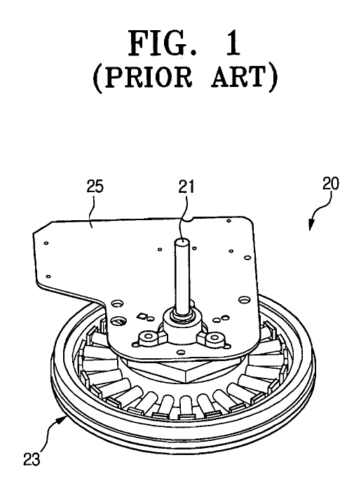

The capstan motor 20 is provided to supply a driving force to drive the take-up reel or the supply reel. As described above with reference to FIG. 1, the capstan motor 20 includes a capstan axle 21, a drive 23 and a metallic substrate 25. The capstan axle 21 is provided to the top surface of the main chassis 10 so that the capstan axle 21 guides the running tape.

The drive 23 and the metallic substrate 25 are provided on the bottom side of the main chassis 10 in the interconnected state. The drive 23 may include a stator and a rotor.

The metallic substrate 25 is a plate-shaped metallic sheet on which various electronic components are provided, including an electric circuit. The metallic substrate 25 is also connected to the head drum 11 to be capable of controlling the driving of the head drum 11 as well as the driving of the drive 23. The metallic substrate 25 is interposed between the drive 23 and the main chassis 10, and spaced from the main chassis 10.

The damping member 30 is removably mounted on the main chassis 10 through a connection opening 14 formed in the main chassis 10. The connection opening 14 is formed in a predetermined position so that an edge of the metallic substrate 25 is exposed through the connection opening 14 in the top surface of the main chassis 10. The damping member 30 is provided to maintain a substantially constant space between the metallic substrate 25 and the main chassis 10 constant. It is preferable, though not necessary, that the damping member 30 is a plastic-molded product.

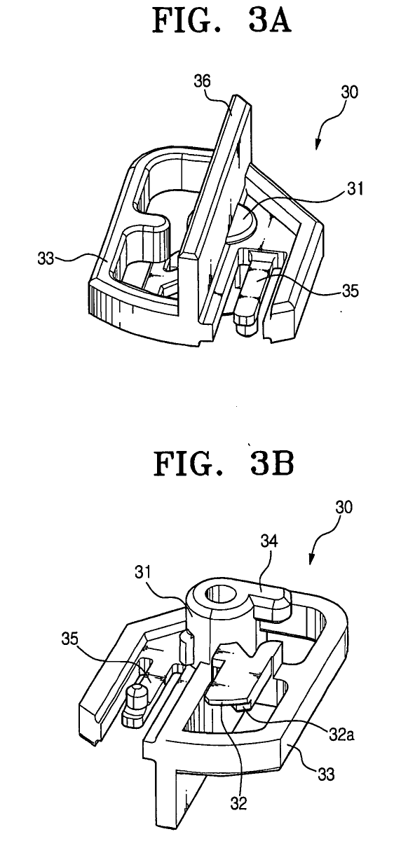

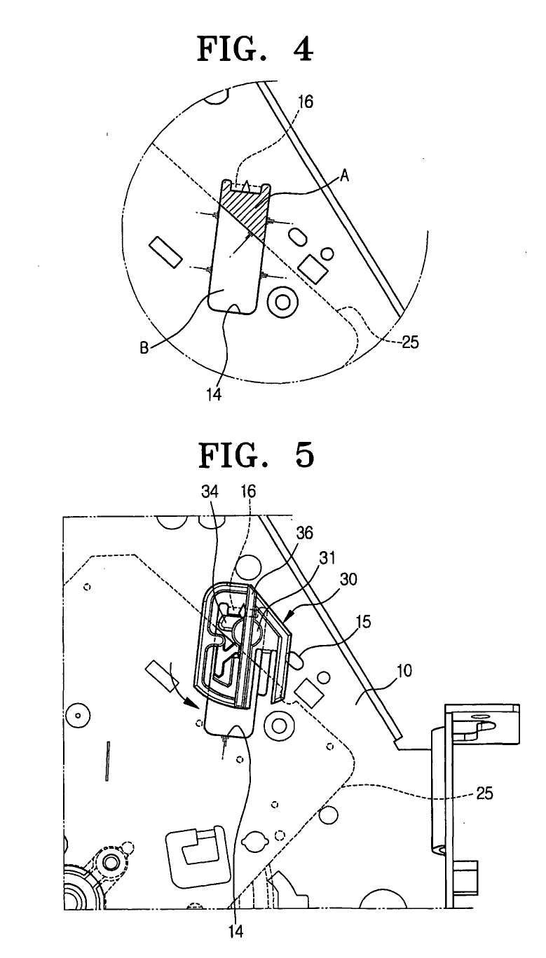

As shown in FIGS. 3A and 3B, which are perspective views illustrating a damping member 30 employed in the tape recording and reproducing apparatus shown in FIG. 2, such a damping member 30 may include an axial part 31, a damping rib 32 extending to a side of the axial part 31, a first clamping rib 33 formed to be upwardly vertically spaced from the top of the damping rib 32, and a second clamping rib 34 formed to be downwardly vertically spaced from the bottom of the damping rib 32. When the damping member 30 is inserted into the connection opening 14, the axial part 31 is inserted into an area located beyond the edges of the metallic substrate 25 (the area A indicated by hatching lines as shown in FIG. 4, which is a top plan view illustrating a main part of a main chassis 10, from which the damping member 30 is removed, employed in the tape recording and reproducing apparatus shown in FIG. 2) and serves as a center of rotation. That is, as shown in FIG. 5, which is a top plan view illustrating a state in which the damping member 30 is inserted into the connection opening 14 of the main chassis 10, if the damping member 30 is inserted into the connection opening 14, the axial part 31 is inserted into the area A. The second clamping rib 34 also passes through the area A without being interfered with by the metallic substrate 25. To this end, the second clamping rib 34 is formed to be projected by a predetermined length to a side of the axial part 31. In addition, the first clamping rib 33 is formed to have an extension larger than the connection opening 14, so that the first clamping rib 33 does not pass through the connection opening 14, whereby the first clamping rib 33 comes into contact with the top surface of the main chassis 10. The damping rib 32 is provided between the first and second clamping ribs 33 and 34, so that the damping rib 32 is inserted into the connection opening 14 and located at the area B facing the metallic substrate 25.

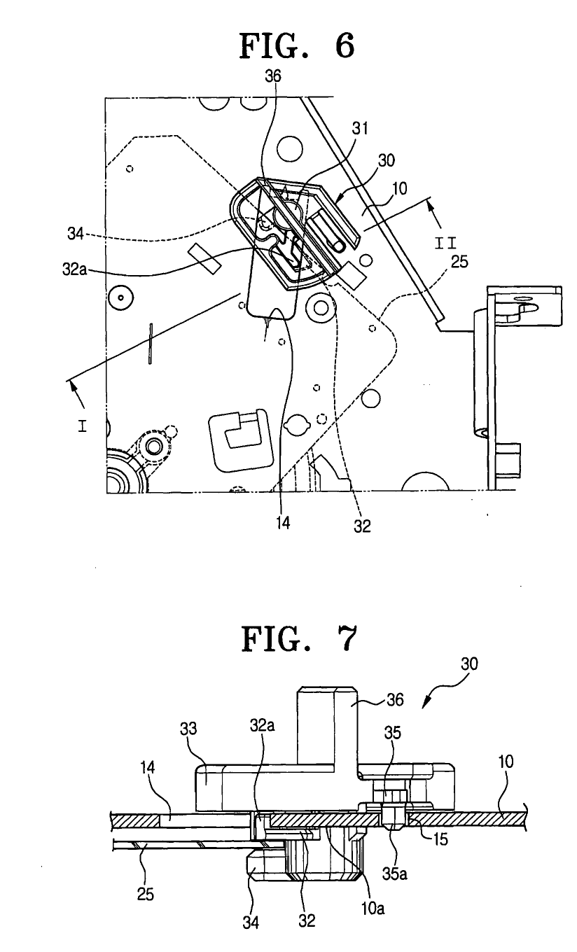

If the damping member 30 is rotated counterclockwise from the state shown in FIG. 5, it is positioned in the state shown in FIG. 6. As shown in FIG. 7, the damping rib 32 is interposed between the metallic substrate 25 and the bottom surface 10a of the main chassis 10. Therefore, it is possible to prevent the metallic substrate 25 from coming into contact with the main chassis 10, even if the metallic substrate 25 is deformed by an external force or vibrations. For this purpose, it is preferable, though not necessary, that the thickness of the damping rib 32 corresponds to the distance between the metallic substrate 25 and the main chassis 10. The main chassis 10 is inserted and clamped between the first clamping member 33 and the damping rib 32. Therefore, it is possible for the main chassis 10 to be rigidly supported by the damping member 30. To this end, it is preferable, though not necessary, that the distance between the damping rib 32 and the first clamping rib 33 corresponds to the thickness of the main chassis 10.

In addition, the second clamping member 34 inserted into the area A is moved to a side below the metallic substrate 10 if the damping member 30 is rotated to the connection position as shown in FIGS. 6 and 7, wherein FIG. 6 is a top plan view illustrating a state in which the damping member is rotated from the state shown in FIG. 5, and FIG. 7 is a cross-sectional view taken along line I-II of FIG. 6. As such, the second clamping member 34 cooperates with the damping rib 32 so that the metallic substrate 25 is sandwiched and clamped between the second clamping member 34 and the damping rib 32. Therefore, the metallic substrate 25 is prevented from being further flexed downward from the main chassis 10, or vibrated. That is, the second clamping rib 34 prevents the downward movement of the metallic substrate 25 in relation to the main chassis 10, and the damping rib 32 prevents the movement of the metallic substrate 25. Accordingly, the metallic substrate 25 can stably maintain its posture against vibrations and external impacts. It is also preferable, though not necessary, that the distance between the second clamping rib 34 and the damping rib 32 corresponds to the thickness of the metallic substrate 25.

The damping rib 32 may be formed with a catching ridge 32aso as to limit the rotating angle of the damping member 30 when the damping member 30 is rotated to the connection position. That is, the catching ridge 32ais inserted into the connection opening 14, wherein the catching ridge 32ais formed to have a height higher than the bottom surface 10a of the main chassis 10. Accordingly, if the damping member 30 is rotated counterclockwise, the catching ridge 32awill be engaged with the edge of the connection opening 14. Only the damping rib 32, which is substantially thinner than the catching ridge 32a, is interposed between the main chassis 10 and the metallic substrate 25.

It is also preferable, though not necessary, that a locking part is additionally provided to prevent the movement of the damping member 30 from the connection position. The locking part includes an elastic rib 35 extending from the first clamping rib 33 to be resiliently deformed, and a locking hole 15 formed in the main chassis 10. The elastic rib 35 is positioned at a height where it is capable of touching the top surface of the main chassis 10, and a locking projection 35ais formed at an end of the elastic rib 35. The locking projection 35ais inserted into and engaged with the locking hole 15 when the damping member 30 is rotated to the connection position.

The connection opening 14 may be formed by cutting a part of the main chassis 10 and downwardly bending the cut part. The bent part 16 prevents the movement of the second clamping rib 34 when the damping member 30 is rotated clockwise so that it is returned to its original position, thus the bent part 16 can serve as a guide for the connection and disconnection positions of the damping member 30.

The damping member 30 may further include a handle 36 projected upwardly of the axial part 31. The damping member 30 can be simply assembled by gripping the handle 36 with a hand, inserting the handle 36 into the connection opening 14, and then rotating the handle 36.

As described above, according to the inventive tape recording and reproducing apparatus, the metallic substrate of the capstan motor and the main chassis can be isolated from each other by providing a damping member between the metallic substrate and the main chassis. In addition, the vibrations generated in the metallic substrate can be absorbed, thereby preventing errors.

Furthermore, the present invention has an advantage in that the assembling and disassembling of the damping member can be simply performed.

Moreover, costs can be saved because no fitting element is needed for assembling the damping member.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A tape recording and/or reproducing apparatus comprising:
a main chassis provided with a head drum;
a capstan motor coupled to the main chassis and provided with a drive and a metallic substrate; and
a damping member removably provided to the main chassis, wherein at least a part of the damping member is interposed between the metallic substrate and the main chassis.

2. The tape recording and/or reproducing apparatus as claimed in claim 1, wherein the main chassis is formed with a connection opening, wherein at least a portion of the damping member extends through the connection opening in response to the damping member being coupled to the main chassis.

3. The tape recording and/or reproducing apparatus as claimed in claim 1, wherein the connection opening is formed to expose an edge of the metallic substrate.

4. The tape recording and/or reproducing apparatus as claimed in claim 2, wherein the drive and the metallic substrate are provided on a bottom surface of the main chassis, and the damping member is coupled to the connection opening from the top surface of the metallic substrate.

5. The tape recording and/or reproducing apparatus as claimed in claim 3, wherein the drive and the metallic substrate are provided on the bottom surface of the main chassis, and the damping member is coupled to the connection opening from the top surface of the metallic substrate.

6. The tape recording and/or reproducing apparatus as claimed in claim 2, wherein the damping member comprises:
an axial part extending through an area not occupied by the metallic substrate in response to the damping member being inserted into the connection opening; and
a damping rib extending from the axial part so that the damping rib is interposed between a bottom surface of the main chassis and the metallic substrate.

7. The tape recording and/or reproducing apparatus as claimed in claim 6, wherein the damping member further comprises a first clamping member formed to be vertically spaced from the damping rib, wherein the first clamping member contacts the top surface of the main chassis and cooperates with the damping rib to clamp the main chassis.

8. The tape recording and/or reproducing apparatus as claimed in claim 7, wherein the damping member further comprises a second clamping member formed to be vertically spaced from the damping rib, wherein the second clamping member contacts the bottom surface of the main chassis and cooperates with the damping rib to clamp the metallic substrate.

9. The tape recording and/or reproducing apparatus as claimed in claim 2, further comprising a locking part to prevent movement of the damping member from a coupled position into which the damping member is rotated by a predetermined angle after having been inserted into the connection opening.

10. The tape recording and/or reproducing apparatus as claimed in claim 9, wherein the locking part comprises:
a locking hole formed adjacent to the connection opening; and
an elastic rib, having a locking projection, formed on the damping member, wherein the locking projection is resiliently inserted into the locking hole in response to the damping member being in the coupled position.

11. The tape recording and/or reproducing apparatus as claimed in claim 3, further comprising a locking part to prevent movement of the damping member from a coupled position into which the damping member is rotated by a predetermined angle after having been inserted into the connection opening.

12. The tape recording and/or reproducing apparatus as claimed in claim 11, wherein the locking part comprises:
a locking hole formed adjacent to the connection opening; and
an elastic rib, having a locking projection, formed on the damping member, wherein the locking projection is resiliently inserted into the locking hole in response to the damping member being in the coupled position.

13. A tape recording and/or reproducing apparatus comprising:
a main chassis;
a capstan motor, having a metallic substrate, coupled to the main chassis; and
a damping member removably provided to the main chassis, wherein the damping member maintains a substantially constant spacing between the main chassis and the metallic substrate.

14. The tape recording and/or reproducing apparatus of claim 13, wherein at least a portion of the damping member is interposed between the metallic substrate and the main chassis.

15. A damping member of a tape recording and/or reproducing apparatus, the apparatus having a main chassis and a capstan motor with a metallic substrate, wherein the damping member is removably provided to the main chassis to maintain a substantially constant spacing between the main chassis and the metallic substrate.

16. The damping member of claim 15, wherein the damping member is plastic-molded.

17. The damping member of claim 15, wherein the damping member comprises:
an axial part to extend through an open portion of the main chassis;
a damping rib extending from the axial part to maintain the constant spacing between the main chassis and the metallic substrate;
a first clamping rib vertically spaced from the damping rib to clamp the main chassis in cooperation with the damping rib; and
a second clamping rib vertically spaced from the damping rib to clamp the metallic substrate in cooperation with the damping rib.

18. The damping member of claim 17, wherein a thickness of the damping rib corresponds to a distance between the metallic substrate and the main chassis.

19. The damping member of claim 17, wherein a distance between the damping rib and the first clamping rib corresponds to a thickness of the main chassis.

20. The damping member of claim 17, wherein a distance between the damping rib and the second clamping rib corresponds to a thickness of the metallic substrate.

21. The damping member of claim 17, further comprising a catching member extending vertically from the damping rib, wherein the damping member rotates into a coupled position to maintain the constant spacing, and the catching member contacts the main chassis to prevent further rotation of the damping member.
